(19) United States
(12) Patent Application Publication
(10) Pub. No.: US 2024/0054390 A1
(43) Pub. Date: Feb. 15, 2024

(54) Leveraging Machine Learning Models to Identify Missing or Incorrect Labels in Training or Testing Data

(71) Applicant: Google LLC, Mountain View, CA (US)

(72) Inventors: James Bradley Wendt, San Francisco, CA (US); Sandeep Tata, San Francisco, CA (US); Lauro Ivo Beltrao Colaco Costa, Kirkland, WA (US); Emmanouil Koukoumidis, Kirkland, WA (US)

(21) Appl. No.: 17/891,635

(22) Filed: Aug. 19, 2022

(30) Foreign Application Priority Data
Aug. 11, 2022 (GR) 20220100675

(51) Int. Cl. G06N 20/00

(52) U.S. Cl. CPC G06N 20/00

(57) ABSTRACT

Labels are often over labeled by machine-learning models and under labeled by human labelers. A solution to the over and under labeling problem is to have both a machine-learning model and a human label a document, then send the document to a parser to determine the discrepancies. The discrepancies are then presented to a human to review and decide whether the machine-learning model identified labels are labels. The feedback is then given to the machine-learning model for further improvement in its confidence calculations which via a confidence threshold determine if the identified labels are presented.

### FIELD

The present disclosure relates generally to machine learning. More particularly, the present disclosure relates to the improvement of label identification and/or quality in training and/or testing data for machine-learning models.

### BACKGROUND

Machine learning is a field of computer science in which models are learned or trained using training data and tested using testing data. In many instances, training or testing data can be generated by humans. For example, a training example can be provided to a human labeler and the human can chose to apply one or more labels to the training example. The labeled data can then be used to train and/or test a machine learning model.

However, humans often make mistakes or miss labels within the training data. These mistakes lead to inaccuracies in machine-learning model training and/or testing, which in turn leads to reduced performance of the model outside of the training data (e.g., when deployed to production) and/or incorrect assessments of model performance.

### SUMMARY

Aspects and advantages of embodiments of the present disclosure will be set forth in part in the following description, or can be learned from the description, or can be learned through practice of the embodiments.

One example aspect of the present disclosure is directed to a computing system with a machine-learning model where the machine-learning model is given a document and labels potential labels within the document. The machine-learning model then assigns the potential label a confidence value which can be filtered via a confidence threshold to determine if the machine-learning model presents the potential labels to a parser. The parser then compares the labels with a pre-labeled dataset. The discrepant labels or newly identified labels are presented to a reviewer. The reviewer will then identify which of these labels are correctly labeled and update the training data accordingly. The model can optionally be retrained on the updated data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of example computing system that performs identification of labels according to example embodiments of the present disclosure.

FIG. 2 depicts a block diagram of an example labeling system according to example embodiments of the present disclosure.

FIG. 3 depicts a block diagram of data flow in an example labeling system according to example embodiments of the present disclosure.

FIG. 4 depicts a flow chart diagram of an example method to perform identification of missing labels or correction of labels according to example embodiments of the present disclosure.

FIG. 5 depicts a flow chart diagram of an example method to perform machine-learning labeling of labels according to example embodiments of the present disclosure.

Reference numerals that are repeated across plural figures are intended to identify the same features in various implementations.

### DETAILED DESCRIPTION

### Overview

Generally, the present disclosure is directed to systems and methods that leverage models to detect missing or incorrect ground-truth annotations in a dataset and surface them to a human for review with an efficient labeling task. This new relabeling task can be highly targeted—the system does not surface an entire document for relabeling, but just a subset of the data example that the model has identified. Further, the relabeling task may be highly simplified—by pre-labeling document portions (e.g., text spans) using model predictions, annotators need only to “Accept/Reject” the suggestions rather than finding and labeling missing annotations manually. Thus, the present disclosure provides a re-labeling workflow so labelers can re-examine entity annotations that existing ML models predict as wrong. Empirical evidence shows that trained models can identify bad ground truth with high accuracy, and higher quality labeled data is critical to having confidence in model performance and quickly improving all models.

More particularly, it is important for many reasons to have correct labels within a set of training data. However, the benefit of improving the quality of machine learning labels is just as, if not more important for the test set than it is for the training set. An analysis of multiple test sets across different corpora revealed missing annotation rates ranging from 5% to 30%, even after multiple rounds of relabeling. Thus, even if the model extracts an error-prone field “correctly”, the test evaluation metrics may indicate the opposite—that the model extracted a value that was not annotated, and thus mark it as a wrong extraction even though it was the human annotator who erred. With an error rate of even 10% it becomes difficult to discern between the performance of a model with an F1 score of e.g., 0.8 and a model with a score of e.g., 0.9 (e.g., the former model may actually be the better model given that it found the missing annotations, but was marked down because of errors in the test set labels). Thus, high quality test data is critical to interpreting evaluation metrics and determining if modeling improvements are in fact meaningful.

As such, the present disclosure provides a relabeling task that surfaces missing or incorrect annotations (predicted by the model) to labelers for confirmation. This will help improve data quality efficiently for the following reasons: The relabeling task can be highly targeted—instead of sending all documents for relabeling, in some implementations, the proposed systems can send only those which are believed with high confidence to be missing specific fields. Further, the proposed system can ask labelers to review only said fields. Thus, the relabeling task can be reviewed in a simplified user interface—instead of asking the labelers to find missing fields on their own and then draw the bounding boxes, the proposed systems can pre-label missing fields and simply ask the labelers to “Accept” or “Reject” the predictions.

More generally, labels are often over-labeled by machine-learning models and under-labeled by human labelers. A solution to the over- and under-labeling problem is to have both a machine-learning model and a human label a document, then send the document to a parser to determine the discrepancies. The discrepancies are then presented to a human to review and decide whether the machine-learning model identified labels are labels.

As examples, the machine-learning model can include one or more of: a binary classifier, sequence labeling model, annotation extraction model, common data environment processor, Human-in-the-Loop, optical character recognition engine, or other similar models. The machine-learning model can determine a confidence threshold by the F1 numbers, where the parameters for precision and recall can be changed based on the desired application in order to identify mislabeled labels. Precision and recall can be used together to form a confidence threshold, where the confidence threshold can be adapted as a function of the relabeling ratio given answers at the relabeling stage in order to reach the desired F1 number, which can be anywhere from 0 to 1. The confidence threshold can be adjusted based upon the input of the human reviewer when they determine if the bad labels or discrepancies are actual labels that should have been identified.

The machine-learning model first identifies potential labels and assigns them a confidence value. The machine-learning model then sends the potential labels through a confidence thresholding process to filter the potential labels. The filtered labels are then compared via a parser with pre-labeled labels to identify discrepant and non-discrepant labels. The discrepant labels are sent to a reviewer who, in some examples, indicates via a yes-no question if the discrepant labels are actual labels or false labels. The confidence threshold can then be adjusted accordingly. The machine-learning model may therefore perform a form of “self-supervision” or “automated supervision” by re-reviewing a previously-labeled document.

The machine-learning model can detect either binary or overlapping labels within a document. The overlapping labels can be identified as one larger label and several smaller labels at the same time to present to the reviewer to decide. The overlapping labels can be compared to the labels given by the labeler to determine the correct label. Further, overlapping labels can be both a larger and several smaller labels that the machine-learning model identifies. Thus, larger labels and their sub-fields can be identified and flagged for review by the machine-learning model. All or some of the smaller labels can be presented to the reviewer depending on the assigned confidence value to the smaller labels.

In some cases, sending the discrepant labels to a reviewer for indication whether the discrepant labels are actual labels can include surfacing the potential label for binary accept or reject input by the reviewer. For example, in some implementations, surfacing the potential label can include surfacing the potential label alongside a bounding box showing a portion of the document proposed to be labeled with the potential label.

In some cases, comparing, via the parser, the filtered labels with previously-generated labels associated with the document to find discrepant labels can correspond to identifying potentially missing labels in which there is no match between one of the potential labels and one of the previously-generated labels. In other cases, finding discrepant labels can correspond to identifying potentially incorrect labels in which different labels are provided by the potential labels and the previously-generated labels for a same portion of the document.

In some implementations, the machine-learning model can work in conjunction with other models or in an ensemble of models in order to attenuate the memorization of errors. The models may train from different starting points of a data set or different subsets of the data. Thus, decreasing the risk of overtraining and error memorization. The ensemble of machine-learning models would then be deployed on a document to identify the labels and the results collated before going through the parser and reviewer.

In some implementations, the proposed techniques can be provided as a cloud service (e.g., as part of a suite of machine learning services provided as a machine learning as a service platform). For example, a user of the platform can upload their labeled data. A model can be trained on the data. The model can be used to identify discrepant labels as described herein. The discrepant labels can be provided to a reviewer (e.g., using a user interface tool included in the cloud platform). Thereafter, the labeled data can be updated can be updated based on the feedback entered by the reviewer. The model can be retrained on the updated data. The retrained model can be deployed (e.g., to various computer devices such as cloud servers or on-device applications).

The technical effect of the machine-learning model includes increased accuracy in label identification, without having to send the machine-learning model through multiple reviews of the same document. The machine-learning model will use less resources and time in order to identify bad or missing labels and increase its overall efficiency. Further, human review of documents for missing labels will be more efficient due to the human only needing to indicate if the identified label is accepted or rejected. Thus, ground-truth identification will be quicker, more accurate and consume less resources.

Another example technical effect of the machine-learning model is that the scanned documents will be reflective of documents in real life. While a human can easily skim a document and identify the relevant fields, this does not necessarily translate into a human drawing bounding boxes around each field. Machine-learning models can identify more, if not all, of these fields and place them automatically into a database. Therefore, searching for certain fields, accounting, and organizing data will be easier and more reflective of the actual data or human actions. Thus, the machine-learning model will make data analysis and accounting more accurate for businesses and other customers.

With reference now to the Figures, example embodiments of the present disclosure will be discussed in further detail.

### Example Devices and Systems

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the machine-learning model can identify labels and present them directly to the human reviewer for review without input from a parser.

In some implementations the machine-learning model can determine the labels without input from a human reviewer. The machine-learning model may have indicated that the labels passed a secondary confidence threshold and thus, do not require review.

In some implementations the machine-learning model can determine the labels without input from a human reviewer. The machine-learning model's confidence threshold may be at such a point and the machine-learning model's accuracy at such a point that the machine-learning model can accurately identify labels without human input.

In some implementations the machine-learning model is trained on a pre-labeled data set, where all of the labels are already identified. Thus, the accuracy of the machine-learning model can be determined based on the labels it flags for review.

In some implementations, the machine-learning model is in conjunction with other machine-learning models for training purposes. One machine-learning model will review the identified labels of the other machine-learning models and indicate if a trainee machine-learning model is correct in its identification. The trainee machine-learning model will then use this to determine its confidence calculation, without any human input or review.

In some implementations the machine-learning model will identify labels without a human labeler or a pre-labeled document or dataset. The machine-learning model, further, will not need a parser to compare the discrepancies as there are no discrepancies to compare. The machine-learning model will instead use the confidence threshold to determine which identified labels are presented to the human reviewer.

In some implementations the machine-learning model is in conjunction with several machine-learning models. The machine-learning models may begin to label labels at different starting points or label a particular subset of the data. Which point they start at or data subset the machine-learning models identify can be determined by a human or computing system based on each machine-learning model's accuracy, specialization or desired specialization in identifying and labeling data.

In some implementations the machine-learning model is in conjunction with several machine-learning models. The machine-learning models are training on pre-labeled and reviewer checked labels. The machine-learning models train on different subsets of the data in order to prevent the over-identification of errors and the under-identification of missing labels. The machine-learning models may be of different or similar types and working at the same data subsets with other machine-learning models of similar or different types.

In some implementations the machine-learning model is in conjunction with other machine-learning models. The machine-learning models train on different starting points of the same data in order to attenuate the memorization of errors. The machine-learning models may be of different or similar types. Several machine-learning models may be working at the same start points while other machine-learning models work at different start points.

In some implementations the machine-learning model flags the labels, in conjunction with other machine-learning models. The group of machine-learning models then determine the correct labels based upon a comparison of the labeled labels and the confidence thresholds of each label.

In some implementations, the machine-learning model identifies mislabeled labels and sends them to the parser to compare. At the comparison the parser will either send both versions on to the reviewer to check which is the correct one or the parser will send one of the versions and use the answer from that to inform its choice. The parser may send one and delete the second if the reviewer confirms the first or may send one then the second if the review denies the first is a label. Further, the parser may send the possibly mislabeled label through a second confidence threshold before presenting it to a reviewer.

In some implementations, an annotation extraction model automatically detects missing labels in a dataset and generates a relabeling task for reviewers to confirm. The relabeling depends on pre-labeling spans using model predictions and reviewers are provided with accept/reject options instead of having to relabel the missing labels manually.

An Optical Character Recognition Engine detects all the text on a page along with their locations and organizes the detected text hierarchically into symbols, words, and blocks along with their bounding boxes. A document type trains the annotation extraction model on the training dataset and uses the evaluation processor to compute maximum F1 thresholds for each field over the training dataset. Once trained the evaluation performed on the test documents can be retrieved into a new evaluation that provides F1 scores in buckets, where each bucket represents a range of confidence scores in 0.1 increments as returned by a remote procedure call. The tool then identifies the maximum F1 threshold using these buckets. The machine-learning model may send the annotations with high confidence scores to the reviewer to accept or reject at this point in the process.

The machine-learning model implements a new tool or library to combine the label data with the predictions produced for documents to be sent to a Human-in-the-Loop aspect for highlighting specific entity types with a confidence score threshold for reviewing and to leverage this capability to highlight the proposed fixes. For the original human-labeled annotations, or any reviewer confirmed annotations the tool sets a score of 1, or the highest available score. The tool copies the original documents, clears the annotations, and sends the documents to the processor for prediction. The processor uses a single document or batch request to process documents with the predictions from the processor in a cloud storage location.

The tool appends the prediction and a new annotation for the entity to match the original document with a score other than 1 or the highest score available. If a document has a high scoring entity or predicted label and the original document has no label annotation for that entity type, then the model reuses the confidence score to lower the confidence threshold without human review. The tool checks that the predicted entities spans do not match exactly with any of the label entities for multi-occurrence entity types. If they match, the model appends the prediction to the original document with its confidence score such that the entities overlap. The tool highlights labels with confidence scores that pass its threshold for Human-in-the-Loop review. The reviewer can choose to adjust the threshold or skip labels with a high enough confidence score. Further, if the bounding box for the label is incorrect, but the label is correct the reviewer can change the size of the bounding box.

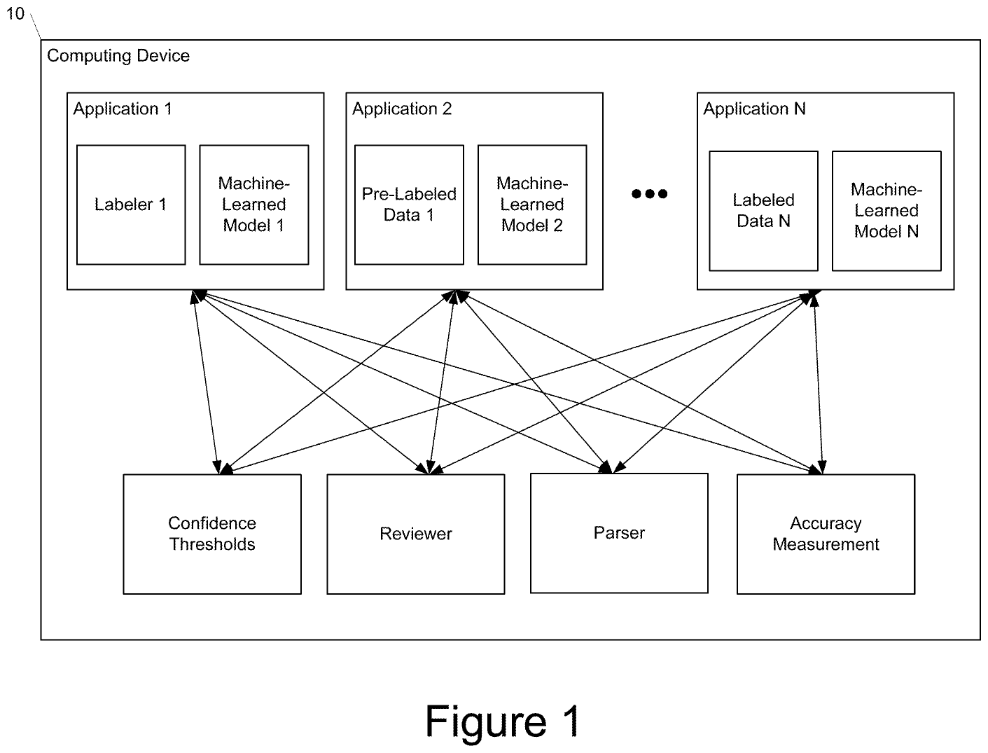

FIG. 1 depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

### Example Model Arrangements

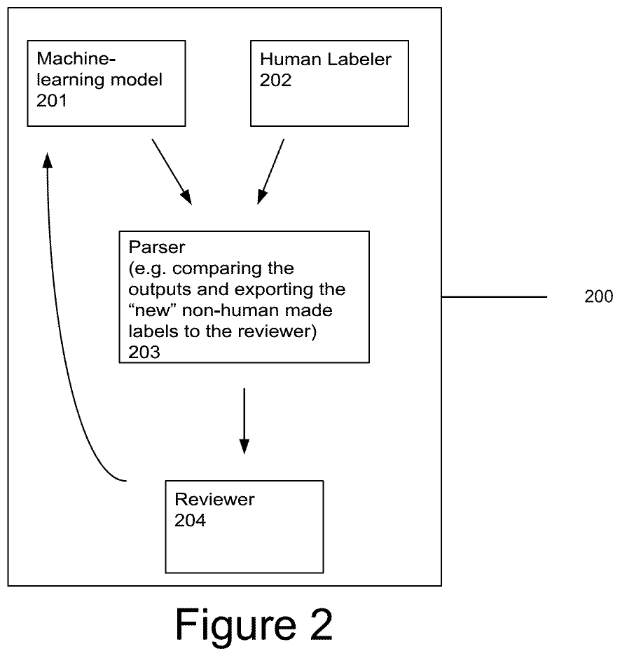

FIG. 2 depicts a block diagram of an example labeling model 200 according to example embodiments of the present disclosure. In some implementations, the labeling model 200 is trained to receive a set of input data 201 and 202 descriptive of labels within a document and, as a result of receipt of the input data the machine-learning program 201 and human labeler 202, provide output data to a parser 203 that determines which labels are presented to a reviewer 204. The reviewer 204 sends the feedback or actual and false labels with labels such as true or false or with a similar meaning, to the machine-learning model 201 for it to adjust its confidence calculations.

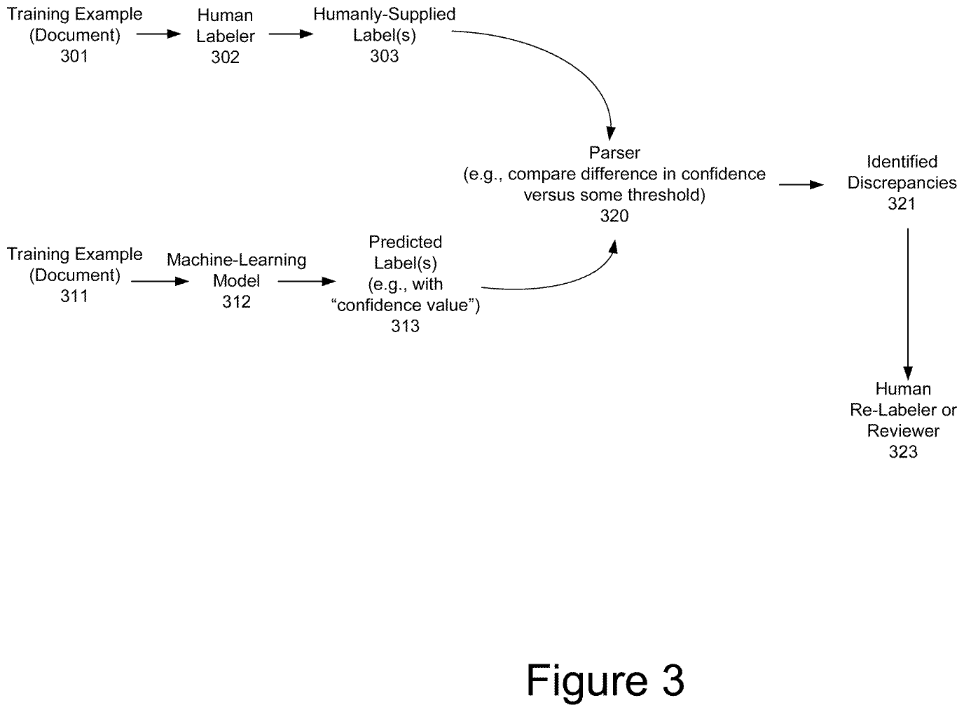

FIG. 3 depicts a block diagram of an example labeling model 300 according to example embodiments of the present disclosure. The labeling model 300 is similar to labeling model 200 of FIG. 2 except that labeling model 300 further includes details about what the machine-learning model, human labeler and parser produce.

FIG. 3 depicts a training example 301 and 311 that are fed to a human labeler 302 and a machine-learning model 312. The human labeler 302 supplies labels 303 to be fed into the parser 320. The machine-learning model 312 predicts the labels and assigns them a confidence value 313 the parser 320 compares the labels 313 to a confidence threshold and then with the humanly supplied labels 303 to identify the discrepancies 321 between the humanly supplied labels 303 and the predicted labels 313 that have passed the confidence threshold 320. The identified discrepancies 321 and finally sent to a human re-labeler 323 to determine if the identified discrepancies 321 are labels missed by the human labeler 302.

### Example Methods

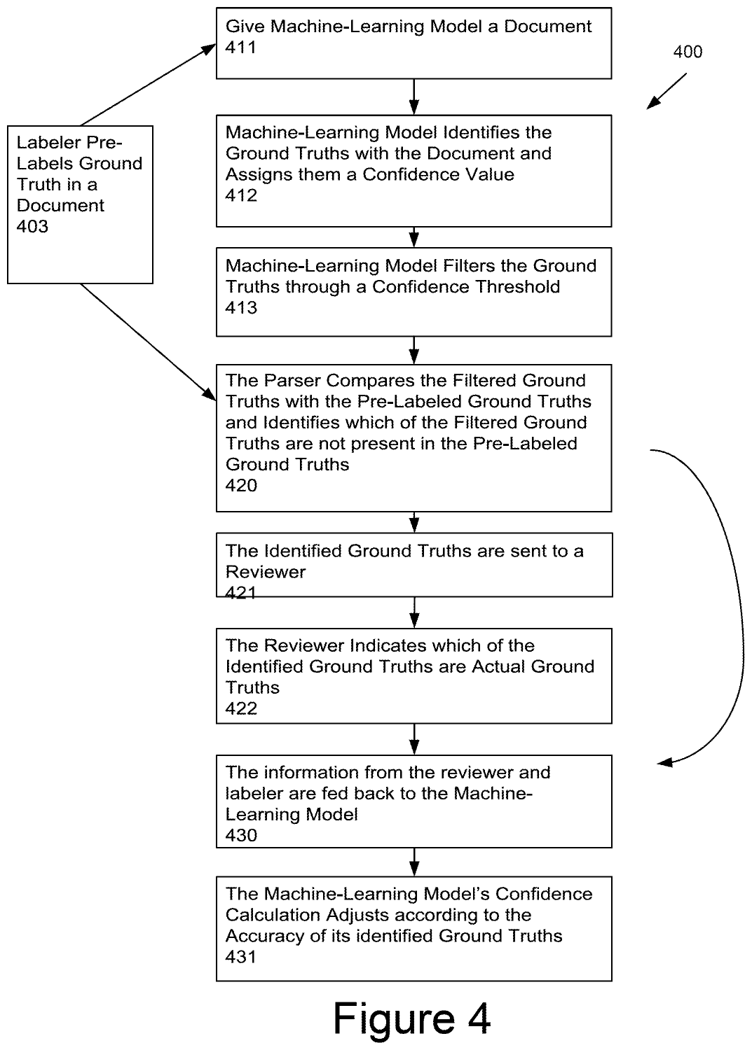

FIG. 4 depicts a flow chart diagram of an example method to perform according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 411, a computing system gives the machine-learning model a document.

At 412, the computing system labels or identifies the labels within the document and assigns them a confidence value based on a confidence calculation.

At 403, a labeler provides labels within the document.

At 413, the computing system filters the machine-learning model identified labels through a confidence threshold and determines if each label is at a high enough confidence to be presented to a parser.

At 420, the computing system sends the labeler's and machine-learning model's identified labels to a parser which detects the differences and sends the overlapping labels to the confidence threshold.

At 421, the computing system sends the machine-learning model identified labels not labeled by the labeler to a reviewer.

At 422, the reviewer identifies which of the labels are actual labels.

At 430, the computing system categorizes the labels into actual labels and false labels and feeds the data to the machine-learning model.

At 431, the computing system adjusts the confidence calculations based on the accuracy of the filtered labels according to the feedback from the parser and reviewer.

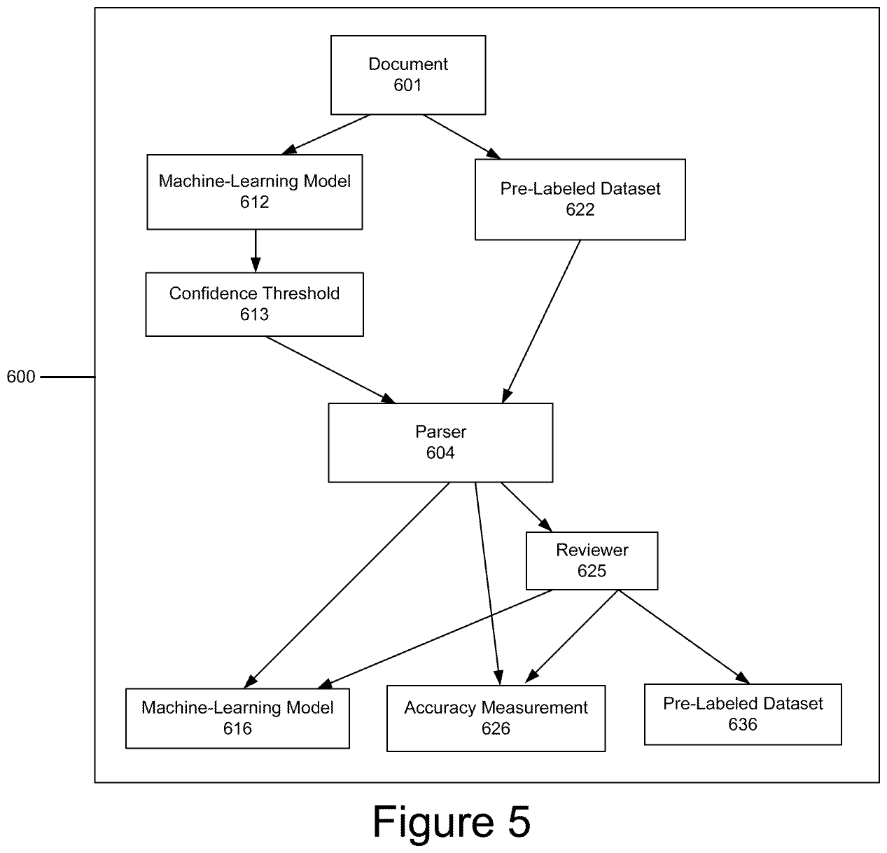

FIG. 5 depicts a flow chart diagram of an example method to perform according to example embodiments of the present disclosure. Although FIG. 5 depicts steps performed in a particular order for purposes of illustration and discussion, the methods of the present disclosure are not limited to the particularly illustrated order or arrangement. The various steps of method 600 can be omitted, rearranged, combined, and/or adapted in various ways without deviating from the scope of the present disclosure.

At 601, a computing system gives a machine-learning model 612 and labeler 622 a document.

At 612, the machine-learning model identifies potential labels and via a confidence calculation assigns them a confidence value.

At 622, the labeler pre-labels the dataset or the computing system pulls up the pre-labeled dataset.

At 613, the confidence threshold filters the potential labels to determine which labels are passed onto a parser 604, based on the chosen parameters for the confidence threshold and the assigned confidence value per label.

At 604, the parser compares the pre-labeled dataset 622 to the filtered labels and sorts them into one of three categories: overlapping labels, pre-labeled only labels, and discrepant ground-truths.

At 625, a reviewer reviews the discrepant labels and identifies the discrepant labels as actual labels or false labels.

At 616, the machine-learning model takes the overlapping labels, the pre-labeled only labels, the false labels, and the actual labels from the reviewer 625 and the parser 604 and uses them to adjust its confidence calculations accordingly.

At 626, the machine-learning model uses the overlapping labels, the pre-labeled only labels, the incorrect labels, and the actual labels from the reviewer 625 and the parser 604 and uses them to calculate the accuracy of its label identification.

At 636, the reviewer 625 sends the actual labels to become a part of the pre-labeled dataset 622.

### Additional Disclosure

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, comprising:
one or more processors;
a machine-learning model; and
one or more non-transitory computer-readable media that store instructions for performing operations, the operations comprising:
identifying, using the machine-learning model, potential labels within a document;
assigning the potential labels a confidence value based upon a confidence calculation;
filtering the potential labels through a confidence threshold;
comparing, via a parser, the filtered labels with previously-generated labels associated with the document to find discrepant labels; and
sending the discrepant labels to a reviewer for indication whether the discrepant labels are actual labels; and
adjusting the document to include the actual labels.

2. The computing system of claim 1, wherein sending the discrepant labels to a reviewer for indication whether the discrepant labels are actual labels comprises surfacing the potential label for binary accept or reject input by the reviewer.

3. The computing system of claim 2, wherein surfacing the potential label comprises surfacing the potential label alongside a bounding box showing a portion of the document proposed to be labeled with the potential label.

4. The computing system of claim 1, wherein comparing, via the parser, the filtered labels with previously-generated labels associated with the document to find discrepant labels comprises identifying potentially missing labels in which there is no match between one of the potential labels and one of the previously-generated labels.

5. The computing system of claim 1, wherein comparing, via the parser, the filtered labels with previously-generated labels associated with the document to find discrepant labels comprises identifying potentially incorrect labels in which different labels are provided by the potential labels and the previously-generated labels for a same portion of the document.

6. The computing system of claim 1, where the machine-learning model detects binary or overlapping labels.

7. The computing system of claim 2, wherein the operations comprise:
using the adjusted document with the actual labels to train other machine-learning models.

8. The computing system of claim 1, where the machine-learning model comprises one or more of:
a binary classifier;
a sequence labeling model;
an annotation extraction model;
a common data environment processor; or
an optical character recognition engine.

9. The computing system of claim 4, where:
the machine-learning model is in conjunction with at least one other machine-learning model; and
the machine-learning models train on different subsets of the data.

10. The computing system of claim 4, where:
the machine-learning model is in conjunction with at least one other machine-learning model; and
the machine-learning models train on different starting points of the same dataset.
